(19) United States
(12) Patent Application Publication
(10) Pub. No.: US 2026/0112802 A1
(43) Pub. Date: Apr. 23, 2026

(54) RADIO FREQUENCY ADJUSTMENT STRUCTURE

(71) Applicant: Suzhou Luxshare Technology Co., Ltd., Suzhou City (CN)

(72) Inventors: Ke-Yu Chen, Suzhou City (CN); Zhen-Guo Song, Suzhou City (CN); Xing-Hua Sun, Suzhou City (CN); Yan-Jiao Cai, Suzhou City (CN)

(73) Assignee: Suzhou Luxshare Technology Co., Ltd., Suzhou City (CN)

(21) Appl. No.: 19/272,293

(22) Filed: Jul. 17, 2025

(30) Foreign Application Priority Data
Oct. 23, 2024 (CN) 202411481613.1

(51) Int. Cl. H01P 1/00; F16B 37/14

(52) U.S. Cl. CPC H01P 1/00; F16B 37/14

(57) ABSTRACT

A radio frequency adjustment structure includes an adjusting screw and a top cover. The adjusting screw includes a cap portion and a rod portion positioned at a central axis of the cap portion. The rod portion defines a first direction. The cap portion includes a number of internal threads spirally surrounding in the first direction. The top cover includes a base portion and a cylinder portion protruding from the base portion. The top cover defines a through hole extending through the cylinder portion and the base portion in the first direction. The cylinder portion includes a number of external threads spirally surrounding in the first direction. The internal threads and the external threads are mated with each other when the rod portion is received in the through hole. An installation depth of the rod portion relative to the top cover is changeable for a frequency adjustment.

### CROSS-REFERENCE TO RELATED APPLICATION

This patent application claims priority of a Chinese Patent Application No. 202411481613.1, filed on Oct. 23, 2024 and titled “RADIO FREQUENCY ADJUSTMENT STRUCTURE”, the entire content of which is incorporated herein by reference.

### TECHNICAL FIELD

This present disclosure relates to a radio frequency (RF) field, in particular a radio frequency adjustment structure.

### BACKGROUND

In an existing radio frequency adjustment structure, a screwing rod and a screwing nut are designed in a split form. The screwing nut includes a plurality of internal threads and the screwing rod includes a plurality of external threads. The screwing rod extends into a top cover through cooperation between the internal threads of the screwing nut and the external threads of the screwing rod, and accordingly, the screwing rod can be suspended and mounted on the top cover. Thus, a user can adjust frequency by varying different depths at which the screwing rod extends below the top cover. However, since the top cover has a through hole through which the screwing rod penetrates, when the screwing rod and the screwing nut are designed in the split form and the screwing rod and the screwing nut are fitted together, debris generated by the helical fit between the internal and external threads will easily fall into a cavity below the top cover through the through hole. Therefore, more and more debris accumulated in the cavity for a long time in the RF adjustment structure in the related art, will more and more affect the frequency regulation effect of the RF adjustment structure.

### SUMMARY

The present disclosure adopts a first technical solution: a radio frequency adjustment structure includes an adjusting screw and a top cover. The adjusting screw includes a cap portion and a rod portion which is positioned at a central axis of the cap portion. The rod portion defines a first direction. The cap portion includes a plurality of internal threads spirally surrounding in the first direction. The top cover includes a base portion and a cylinder portion protruding upwards from the base portion. The top cover defines a through hole extending through the cylinder portion and the base portion from top to bottom in the first direction. The cylinder portion includes a plurality of external threads spirally surrounding in the first direction. The internal threads and the external threads are mated with each other when the rod portion is received in the through hole. An installation depth of the rod portion relative to the top cover is changeable for a frequency adjustment.

The present disclosure adopts a second technical solution: a radio frequency adjustment structure includes a plurality of adjusting screws and a top cover. Each adjusting screw includes a cap portion and a rod portion positioned at a central axis of the cap portion. The rod portion defines a first direction. Each cap portion includes a plurality of internal threads spirally surrounding in the first direction. The top cover includes a base portion and a plurality of cylinder portions protruding upwards from the base portion. The top cover defines a plurality of through holes. Each through hole extends through a corresponding cylinder portion and the base portion from top to bottom in the first direction. Each cylinder portion includes a plurality of external threads spirally surrounding in the first direction. Each rod portion is received in a corresponding through hole so that the internal threads and the external threads are mated with each other for frequency adjustments.

### BRIEF DESCRIPTION OF DRAWINGS

FIG. 1 is a first perspective, assembled view of a part of a radio frequency adjustment structure in accordance with an embodiment of the present disclosure;

FIG. 2 is a second perspective, assembled view of the above-mentioned part of the radio frequency adjustment structure when taken from another angle;

FIG. 3 is a first perspective, exploded view of the above-mentioned part of the radio frequency adjustment structure;

FIG. 4 is a second perspective, exploded view of the above-mentioned part of the radio frequency adjustment structure;

FIG. 5 is a top view of the radio frequency adjustment structure of FIG. 1;

FIG. 6 is a cross-sectional view taken along line A-A of FIG. 5 and the radio frequency adjustment structure is in an assembled state;

FIG. 7 is a cross-sectional view taken along line A-A of FIG. 5 and the radio frequency adjustment structure is in an exploded state;

FIG. 8 is a perspective, assembled view of the radio frequency adjustment structure of FIG. 1;

FIG. 9 is a first perspective view of the radio frequency adjustment structure, when an adjusting screw and a top cover is assembled, and a combination of the adjusting screw and the top cover is separated from a bottom base;

FIG. 10 is a second perspective view of the radio frequency adjustment structure, when the adjusting screw and the bottom base is assembled, and a combination of the adjusting screw and the bottom base is separated from the top cover;

FIG. 11 is a third perspective view of the radio frequency adjustment structure, when the adjusting screw, the top cover and the bottom base are respectively separated;

FIG. 12 is a top view of FIG. 8;

FIG. 13 is a cross-sectional view taken along line B-B of FIG. 12; and

FIG. 14 is a cross-sectional view taken along line C-C of FIG. 12.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

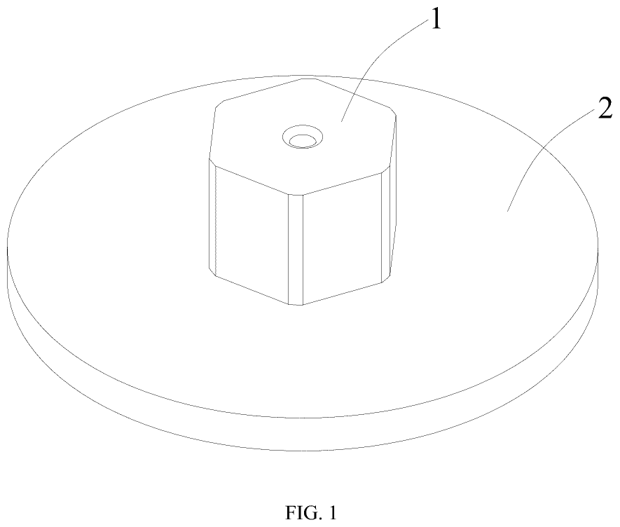

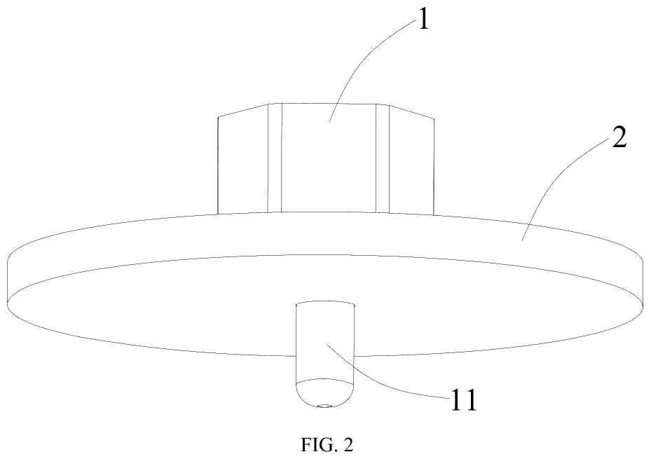

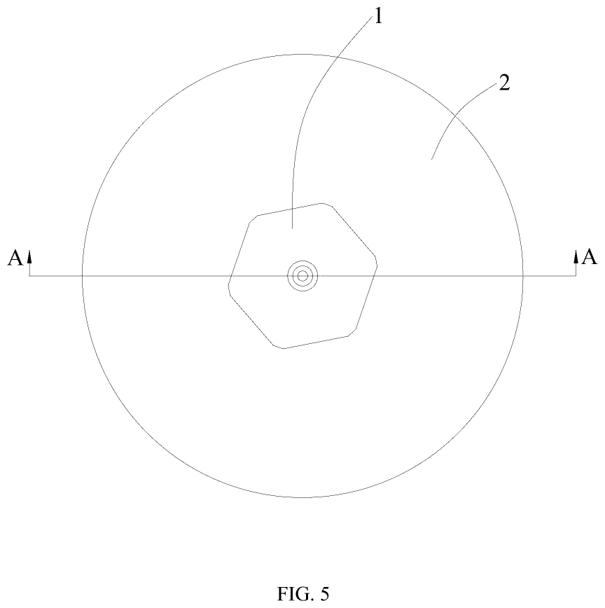

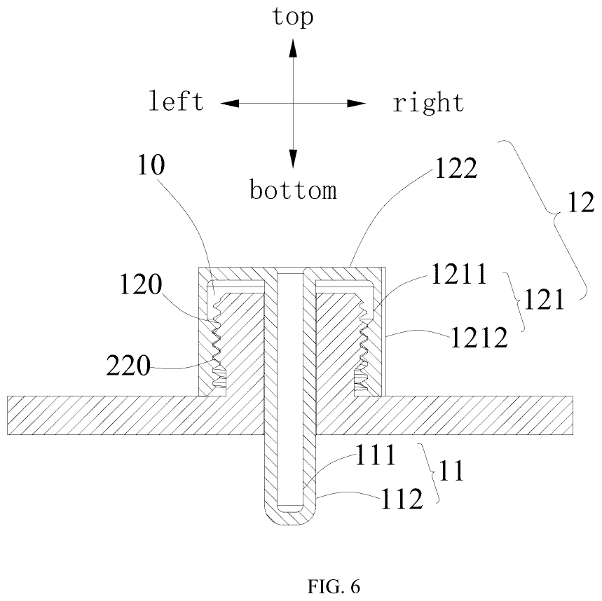

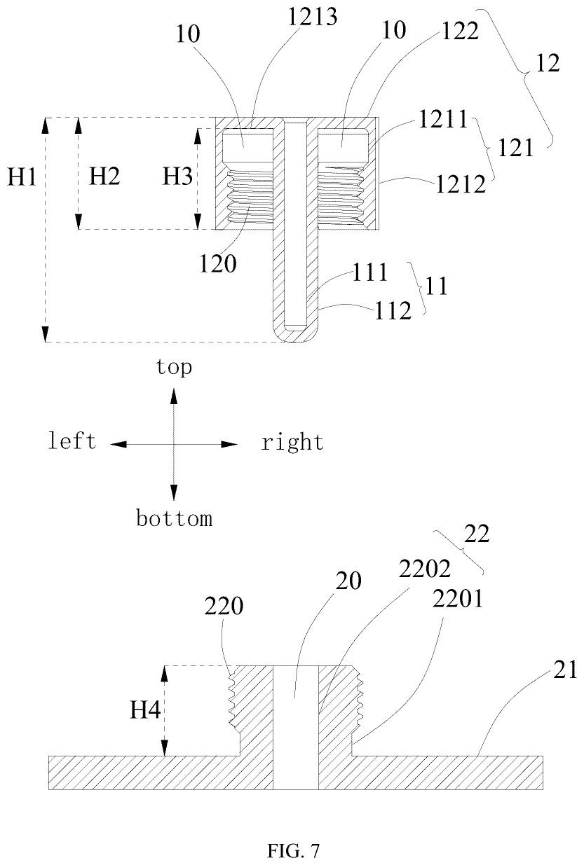

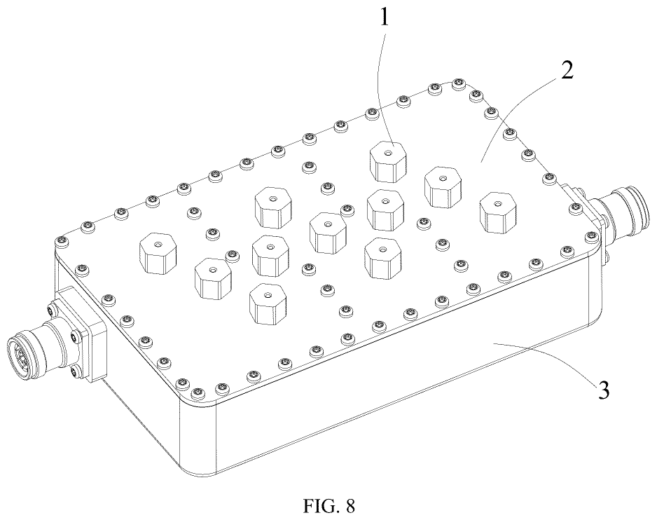

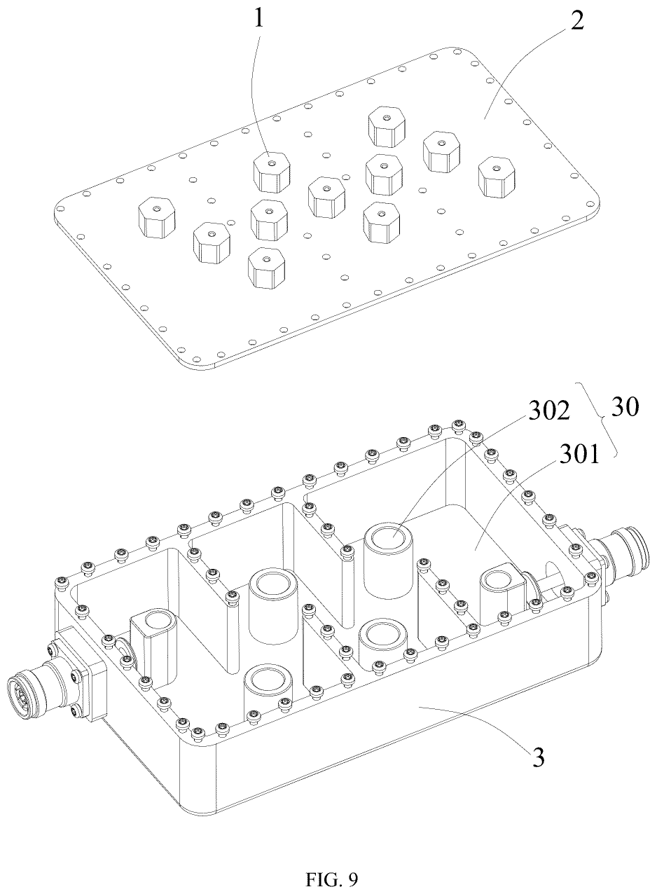

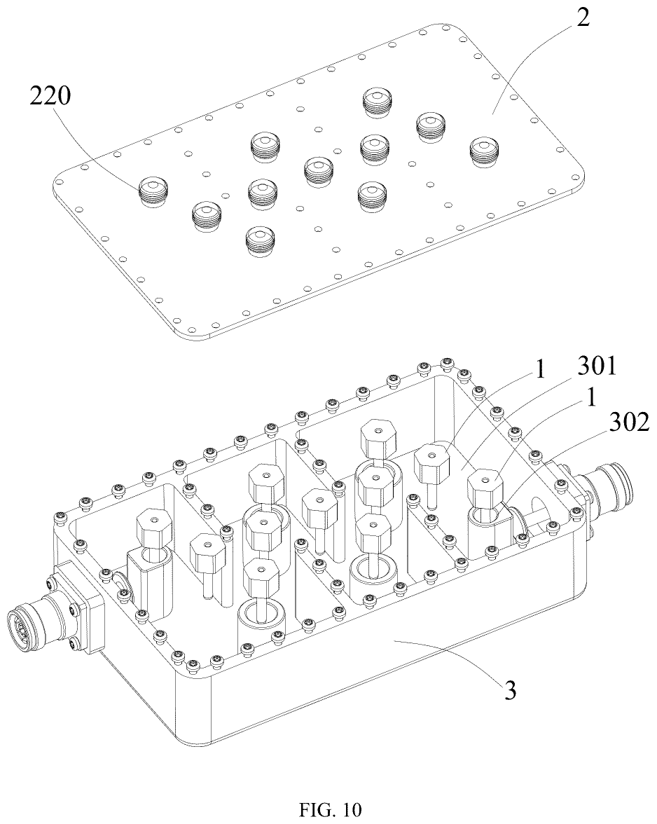

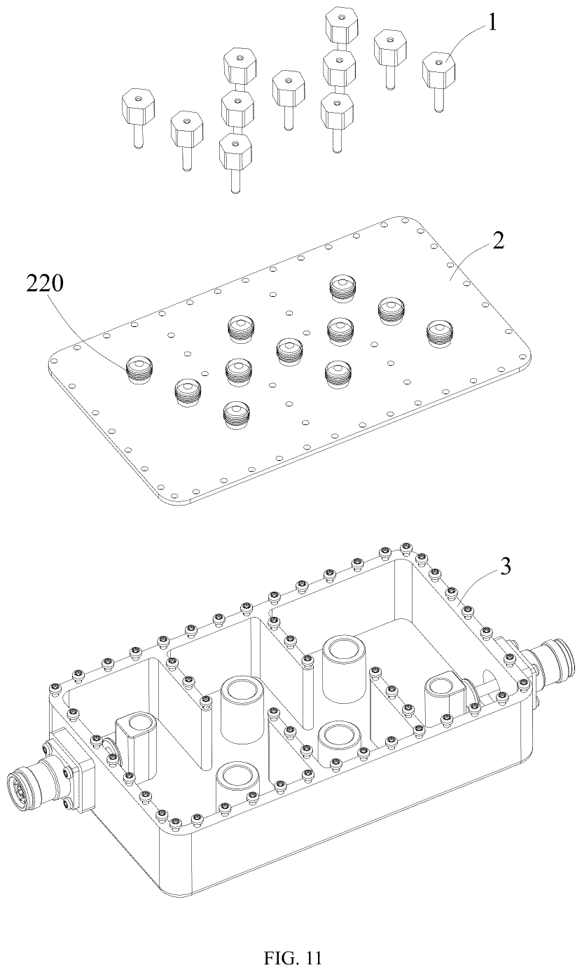

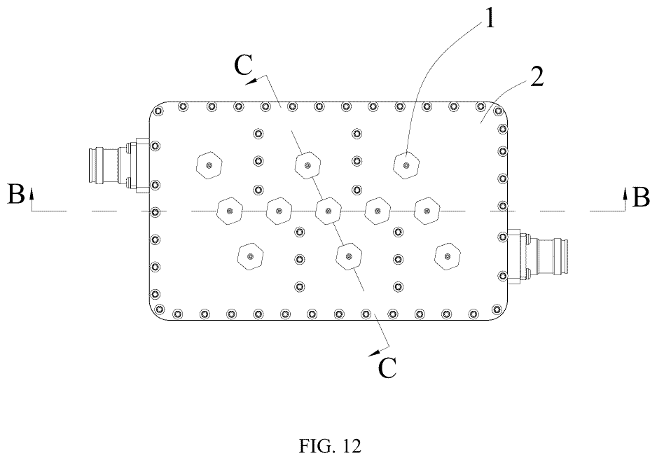

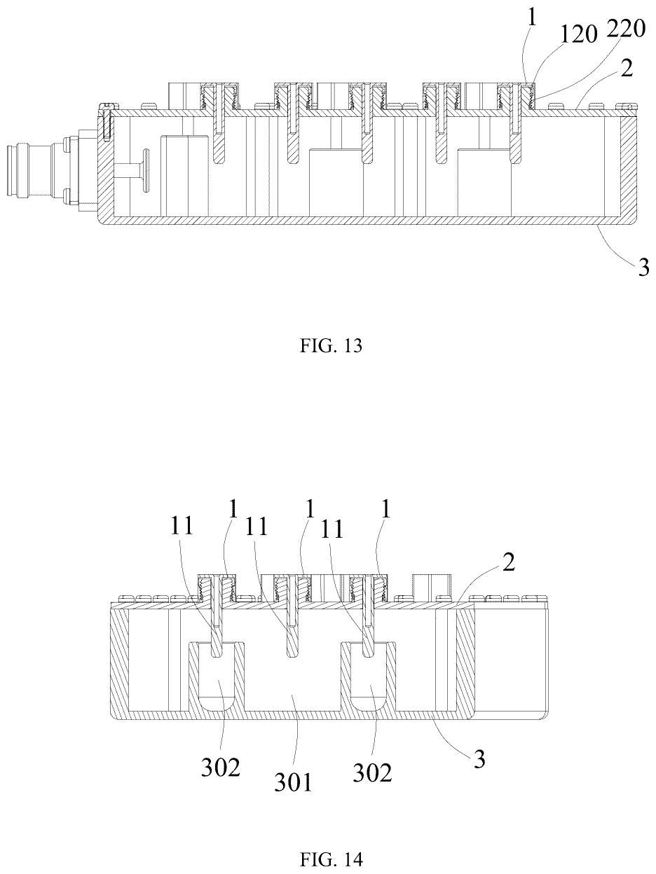

Referring to FIG. 1 to FIG. 14, a radio frequency adjustment structure in accordance with an embodiment of the present disclosure includes an adjusting screw 1 and a top cover 2. The adjusting screw 1 includes a cap portion 12 and a rod portion 11 positioned at a central axis of the cap portion 12. The rod portion 11 defines a vertical/first direction, and the cap portion 12 includes a plurality of internal threads 120 spirally surrounding in the vertical direction. The top cover 2 includes a base portion 21 and a cylinder portion 22 protruding from the base portion 21. The top cover 2 defines a through hole 20 extending through the cylinder portion 22 and the base portion 21 from top to bottom in the vertical direction. The cylinder portion 22 includes a plurality of external threads 220 spirally surrounding in the vertical direction. The internal threads 120 and the external threads 220 are mated with each other when the rod portion 11 is received in the through hole 20. An installation depth of the rod portion 11 relative to the top cover 2 is changeable for a frequency adjustment. Referring to FIG. 6 and FIG. 7, the vertical direction is also defined as a top-bottom direction.

In the present disclosure, because the internal threads 120 are arranged on the cap portion 12 of the adjusting screw 1 and the external threads 220 are arranged on the cylinder portion 22 of the top cover 2, when the rod portion 11 penetrates the through hole 20 on the cylinder portion 22 of the top cover 2, the adjusting screw 1 can adjust its installation depth relative to the top cover 2 relying on the cooperation between the internal threads 120 and the external threads 220 for adjusting the frequency, and because debris which is produced by the spiral fit between the internal threads 120 and the external threads 220 is blocked outside the top cover 2 by the cylinder portion 22 of the top cover 2, and the debris is prevented from falling below the top cover 2 through the through hole 20, therefore, intermodulation is improved and frequency effect is further optimized.

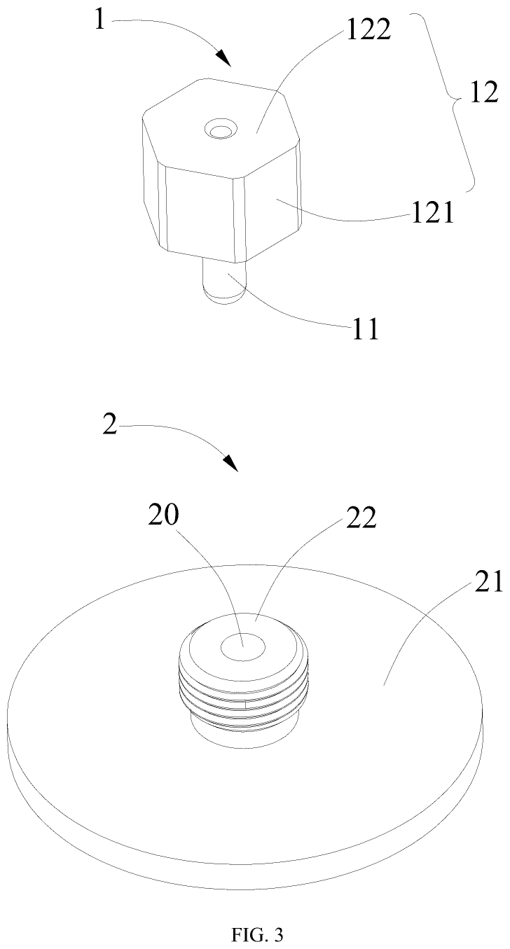

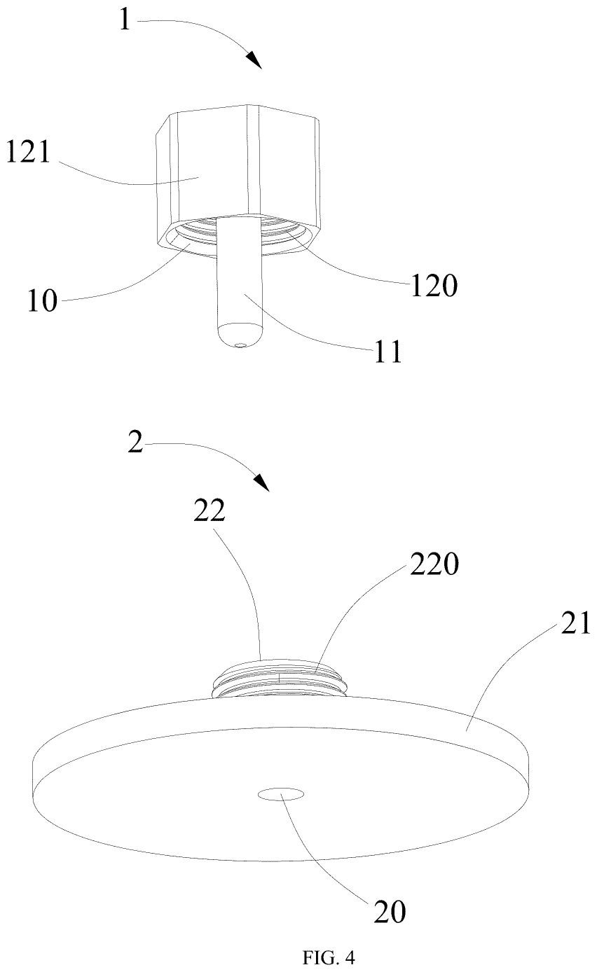

Referring to FIG. 3, FIG. 4, FIG. 6 and FIG. 7, the cap portion 12 includes an eave portion 121 extending in the vertical direction and the rod portion 11 is surrounded by the eave portion 121. The internal threads 120 are arranged on the eave portion 121 and face the rod portion 11. It is suggested to imagine that the so-called cap portion 12 is similar to a bottle cap, an inner wall surface 1211 of the bottle cap is a round surface and so, the internal threads 120 are spirally surrounded on the inner wall surface 1211 of the vertical extension of the cap. The internal threads 120 face the rod portion 11, so that the internal threads 120 are convenient to screw with the external threads 220.

Referring to FIG. 3, FIG. 4, FIG. 6 and FIG. 7, the base portion 21 defines a horizontal/second direction perpendicular to the vertical/first direction. Referring to FIG. 6 and FIG. 7, the horizontal direction is also defined as a left-right direction. The cap portion 12 includes a plate portion 122 extending in the horizontal direction. The plate portion 122 is integrally connected between the rod portion 11 and the eave portion 121. The cap portion 12 is similar to a so-called bottle cap. Of course, it can be easily understood that the bottle cap includes a plate portion 122 that extends horizontally at the top thereof. The effect of the plate portion 122 is to connect the rod portion 11 extending in the vertical direction and the eave portion 121 extending in the vertical direction.

Referring to FIG. 1 to FIG. 14 and particularly referring to FIG. 6 and FIG. 7, the rod portion 11 extends downward from the plate portion 122. An extension height of the rod portion 11 in the vertical direction is defined as a first height H1, an extension height of the eave portion 121 in the vertical direction is defined as a second height H2, and the second height H2 is less than the first height H1. The rod portion 11 is inserted into the through hole 20 and extends below the top cover 2, partially stretching out of the top cover 2 for adjusting its installation depth relative to the top cover 2. The cap portion 12 of the adjusting screw 1 can screw with the cylinder portion 22 of the top cover 2 for suspending and positioning purpose, relying on the fit between the internal threads 120 and the external threads 220.

Referring to FIG. 1 to FIG. 7, the second height H2 is ⅓ to ½ of the first height H1. In one aspect, when the second height H2 is ½ of the first height H1, it's not hard to understand that the rod portion 11 has an exposed part relative to the eave portion 121 and an unexposed part relative to the eave portion 121, and the exposed part is basically equal to the unexposed part. Each of the exposed part and the unexposed part occupies half length of the eave portion 121. The rod portion 11 has half the length for adjusting its installation depth relative to the top cover 2. An adjustment range of the frequency is relatively small when the second height H2 is ½ of the first height H1. In another aspect, when the second height H2 is ⅓ of the first height H1, it's not hard to understand that the exposed part of the rod portion 11 relative to the eave portion 121 accounts for more than half, so that the adjustment range of the frequency increases. Of course, the second height H2 and the first height H1 are not specially limited, and the second height H2 only needs to be satisfied that it is less than the first height H1, so that the rod portion 11 has an exposed part relative to the eave portion 121 is OK.

Referring to FIG. 4 and FIG. 7, the adjusting screw 1 is made from an injected-molding process to be an integral one, and particularly, the rod portion 11 can be regarded as being deposited downward from a middle part of the plate portion 122 in the process of injection. An annular space 10 is defined between the rod portion 11, the plate portion 122 and the eave portion 121 and therefore, at least part of the cylinder portion 22 is located in the annular space 10. The effect of the annular space 10 is that: when the adjusting screw 1 is adjusted relative to the top cover 2 along the top-bottom direction, the annular space 10 accommodates part of the cylinder portion 22 and provides corresponding activity space for the cylinder portion 22.

Referring to FIG. 3, FIG. 4 and FIG. 7, the rod portion 11 includes an inner surface 111 and an outer surface 112 which are oppositely arranged. A bottom end of the rod portion 11 which is far away from the plate portion 122 is closed, and a top end of the rod portion 11 which is near to the plate portion 122 is open. The purpose of such arrangement is that, it facilitates the integrated molding of the adjusting screw 1 for one aspect, and for another aspect, it is facilitates reducing the weight of the adjusting screw 1 and realizing the lightweight of the product.

Referring to FIG. 6 and FIG. 7, the eave portion 121 includes an inner wall surface 1211 and an outer wall surface 1212 that are oppositely arranged. In the illustrated embodiment of the present disclosure, the inner wall surface 1211 is a circular surface, which is conducive to the etching and forming of the internal threads 120 on the inner wall surface 1211. The outer wall surface 1212 is formed by a plurality of planes. Some head edges of the planes and some tail edges of the planes are connected one-by-one in sequence. The outer edge of the plate portion 122 is correspondingly polygonal (in the present embodiment, the outer edge of the outer wall surface 1212 looks like an outer contour of a hex nut) and the above-mentioned polygonal shape of the adjusting screw 1 makes sure that the adjusting screw 1 is conveniently to be adjusted with a tool.

Referring to FIGS. 6 and 7, the cylinder portion 22 includes an inner rim surface 2201 and an outer rim surface 2202 which are arranged in opposite directions. It is to be noted that, the outer rim surface 2202 is a circular surface, which facilitates an etching and molding of the external threads 220 on the outer rim surface 2202. It is also noted that, a height of the etching of the internal threads 120 on the inner wall surface 1211 is the same as a height of the etching of the external threads 220 on the outer rim surface 2202. That is, when the highest position of the internal threads 120 is flush with the highest position of the external threads 220, the lowest position of the internal threads 120 is also flush with the lowest position of the external threads 220. Thus, it can be ensured that the internal threads 120 realizes an exactly matched engagement state with the external threads 220.

Referring to FIG. 7, the eave portion 121 further includes an inner bottom surface 1213 and the cap portion 12 further includes a mouth portion 123. A distance from the inner bottom surface 1213 to the mouth portion 123 is defined as a third height H3, a height of the cylinder portion 22 is defined as a fourth height H4, and that the third height H3 is no less than the fourth height H4. That is to say, the present disclosure provides for a distance between both a bottom end of the external threads 220 and an upper surface of the base portion 21 and also provides for a distance between the mouth portion 123 and the inner bottom surface 1213, to facilitate a screwing of the internal threads 120 with the external threads 220 to go further downward for a distance, after a screwing of the internal threads 120 with the external threads 220 into a complete fit in place. Thus, the present disclosure has an advantage for minimizing the number of turns of screwing between the internal threads 120 and the external threads 220 and enabling the adjustment depth of the adjusting screw 1 to be maximized too.

Referring to FIGS. 7 to 14, the radio frequency adjustment structure of the present disclosure further includes a bottom base 3. The bottom base 3 is located below the top cover 2 and a cavity 30 is formed between the top cover 2 and the bottom base 3. The adjusting screw 1 is mounted on the top cover 2 in a manner of threads and extends into the cavity 30 to perform a frequency adjustment. It is particularly noted that the cavity 30 includes two types: the first type refers to a first cavity 301 surrounded by an outer wall around the bottom base 3; the second type refers to a second cavity 302 surrounded by a circled wall inside the outer wall of the bottom base 3. A first wall thickness of the first chamber 301 is different from a second wall thickness of the second chamber 302. It is understood that in a preferred embodiment, the first wall thickness of the second chamber 302 is greater than the second wall thickness of the first chamber 301. Therefore, the shielding effect is good and it is more significant and efficient in terms of the efficiency of regulating the frequency.

Referring to FIGS. 7 to 14, the radio frequency adjustment structure of the present disclosure further includes a plurality of adjusting screws 1, in which some adjusting screws 1 extending into the first cavity 301 and the rest of the adjusting screws 1 extending into the second cavity 302. By this means, the adjusting screws 1 can be categorized into different types and the frequency can be adjusted in a targeted manner. For example, if a first regulating efficiency of the adjusting screws 1 in the first chamber 301 is so-called one-level, a second regulating efficiency of the adjusting screws 1 in the second chamber 302 can be called two-level. That is, the second regulating efficiency of the adjusting screws 1 in the second chamber 302 is twice the first regulating efficiency of the adjusting screws 1 in the first chamber 301. In this way, the frequency adjustment of the present disclosure can be adjusted and controlled by a plurality of adjusting screws 1 which have different adjusting efficiencies in the first and second chambers 301, 302, respectively.

Therefore, a second technical solution is disclosed by the present disclosure as following: a radio frequency adjustment structure includes a plurality of adjusting screws 1 and a top cover 2. Each adjusting screw 1 includes a cap portion 12 and a rod portion 11 positioned at a central axis of the cap portion 12. The rod portion 11 defines a vertical direction. Each cap portion 12 includes a plurality of internal threads 120 spirally surrounding in the vertical direction. The top cover 2 includes a base portion 21 and a plurality of cylinder portions 22 protruding from the base portion 21. The top cover 2 defines a plurality of through holes 20. Each through hole 20 extends through a corresponding cylinder portion 22 and the base portion 21 from top to bottom in the vertical direction. Each cylinder portion 22 includes a plurality of external threads 220 spirally surrounding in the vertical direction. Each rod portion 11 is received in a corresponding through hole 20 so that the internal threads 120 and the external threads 220 are mated with each other for frequency adjustments.

The internal threads 120 of the present disclosure are arranged on the cap portion 12 of the adjusting screw 1 and the external threads 220 of the present disclosure are arranged on the cylinder portion 22 of the top cover 2, so that when the rod portion 11 of the adjusting screw 1 is threaded through the through hole 20 of the cylinder portion 22 of the top cover 2, the adjusting screw 1 is able to rely on the cooperation between the internal threads 120 and the external threads 220 to adjust its installation depth with respect to the top cover 2 in order to adjust the frequency. At the same time, the debris that is generated by the helical fit between the inner and external threads 120, 220 is blocked by the cylinder portion 22 of the top cover 2 on the outside of the top cover 2, which prevents the debris from falling into the cavity 30 below the top cover 2 via the through hole 20. Therefore, the radio frequency adjustment structure of the present disclosure improves the intermodulation, and further optimize the effect of the frequency.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A radio frequency adjustment structure, comprising:
an adjusting screw, the adjusting screw comprising a cap portion and a rod portion, the rod portion being positioned at a central axis of the cap portion, the rod portion defining a first direction, the cap portion comprising a plurality of internal threads spirally surrounding in the first direction; and
a top cover, the top cover comprising a base portion and a cylinder portion protruding from the base portion, the top cover defining a through hole extending through the cylinder portion and the base portion in the first direction, the cylinder portion comprising a plurality of external threads spirally surrounding in the first direction, the internal threads and the external threads being mated with each other when the rod portion is received in the through hole, and an installation depth of the rod portion relative to the top cover being changeable for a frequency adjustment.

2. The radio frequency adjustment structure according to claim 1, wherein the cap portion comprises an eave portion extending in the first direction, the rod portion is surrounded by the eave portion, the internal threads are provided on the eave portion, and the internal threads face the rod portion.

3. The radio frequency adjustment structure according to claim 2, wherein the base portion defines a second direction perpendicular to the first direction, the cap portion comprises a plate portion extending in the second direction, and the plate portion is integrally connected between the rod portion and the eave portion.

4. The radio frequency adjustment structure according to claim 3, wherein the rod portion extends downward from the plate portion, an extension height of the rod portion in the first direction is defined as a first height H1, an extension height of the eave portion in the first direction is defined as a second height H2, and the second height H2 is less than the first height H1.

5. The radio frequency adjustment structure according to claim 3, wherein an annular space is defined between the rod portion, the plate portion and the eave portion; and wherein at least part of the cylinder portion is located in the annular space.

6. The radio frequency adjustment structure according to claim 5, wherein the rod portion comprises an inner surface and an outer surface, the inner surface and the outer surface are oppositely arranged, and wherein a bottom end of the rod portion away from the plate portion is closed, and a top end of the rod portion adjacent to the plate portion is open.

7. The radio frequency adjustment structure according to claim 3, wherein the eave portion comprises an inner wall surface and an outer wall surface that are oppositely arranged, the inner wall surface is a circular surface, the outer wall surface is formed by a plurality of planes, head edges of the planes and tail edges of the planes are connected one-by-one in sequence so that an outer edge of the plate portion is polygonal.

8. The radio frequency adjustment structure according to claim 7, wherein the cylinder portion comprises an inner rim surface and an outer rim surface which are arranged in opposite directions, and the outer rim surface is a circular surface; and wherein an etching height of the internal threads on the inner wall surface is the same as an etching height of the external threads on the outer rim surface.

9. The radio frequency adjustment structure according to claim 8, wherein the eave portion further comprises an inner bottom surface, and the cap portion further comprises a mouth portion, a distance from the inner bottom surface to the mouth portion is defined as a third height H3, a height of the cylinder portion is defined as a fourth height H4, and wherein the third height H3 is no less than the fourth height H4.

10. The radio frequency adjustment structure according to claim 1, further comprising a bottom base, wherein the bottom base is located below the top cover, a cavity is formed between the top cover and the bottom base, and the adjusting screw is mounted on the top cover and capable of extending into the cavity.

11. A radio frequency adjustment structure, comprising:
a plurality of adjusting screws, each adjusting screw comprising a cap portion and a rod portion, the rod portion being positioned at a central axis of the cap portion, the rod portion defining a first direction, each cap portion comprising a plurality of internal threads spirally surrounding in the first direction; and
a top cover, the top cover comprising a base portion and a plurality of cylinder portions protruding from the base portion, the top cover defining a plurality of through holes, each through hole extending through a corresponding cylinder portion and the base portion from top to bottom in the first direction, each cylinder portion comprising a plurality of external threads spirally surrounding in the first direction, each rod portion being received in a corresponding through hole so that the internal threads and the external threads are correspondingly and mated with each other for frequency adjustments.

12. The radio frequency adjustment structure according to claim 11, wherein the cap portion comprises an eave portion extending in the first direction, the rod portion is surrounded by the eave portion, the internal threads are provided on the eave portion, and the internal threads face the rod portion.

13. The radio frequency adjustment structure according to claim 12, wherein the base portion defines a second direction perpendicular to the first direction, the cap portion comprises a plate portion extending in the second direction, and the plate portion is integrally connected between the rod portion and the eave portion.

14. The radio frequency adjustment structure according to claim 13, wherein the rod portion extends downward from the plate portion, an extension height of the rod portion in the first direction is defined as a first height H1, an extension height of the eave portion in the first direction is defined as a second height H2, and the second height H2 is less than the first height H1.

15. The radio frequency adjustment structure according to claim 13, wherein an annular space is defined between the rod portion, the plate portion and the eave portion; and wherein at least part of the cylinder portion is located in the annular space.

16. The radio frequency adjustment structure according to claim 15, wherein the rod portion comprises an inner surface and an outer surface, the inner surface and the outer surface are oppositely arranged, and wherein a bottom end of the rod portion away from the plate portion is closed, and a top end of the rod portion adjacent to the plate portion is open.

17. The radio frequency adjustment structure according to claim 13, wherein the eave portion comprises an inner wall surface and an outer wall surface that are oppositely arranged, the inner wall surface is a circular surface, the outer wall surface is formed by a plurality of planes, head edges of the planes and tail edges of the planes are connected one-by-one in sequence so that an outer edge of the plate portion is polygonal.

18. The radio frequency adjustment structure according to claim 17, wherein the cylinder portion comprises an inner rim surface and an outer rim surface which are arranged in opposite directions, and the outer rim surface is a circular surface; and wherein an etching height of the internal threads on the inner wall surface is the same as an etching height of the external threads on the outer rim surface.

19. The radio frequency adjustment structure according to claim 18, wherein the eave portion further comprises an inner bottom surface and the cap portion further comprises a mouth portion, a distance from the inner bottom surface to the mouth portion is defined as a third height H3, a height of the cylinder portion is defined as a fourth height H4, and wherein the third height H3 is no less than the fourth height H4.

20. The radio frequency adjustment structure according to claim 11, further comprising a bottom base, wherein the bottom base is located below the top cover, a cavity is formed between the top cover and the bottom base, and the adjusting screw is mounted on the top cover and capable of extending into the cavity.
